(19) United States
(12) Patent Application Publication
(10) Pub. No.: US 2006/0078324 A1
(43) Pub. Date: Apr. 13, 2006

(54) Digital camera

(75) Inventors: Koji Yasuda, Osaka (JP); Yoshito Konishi, Osaka (JP); Tomoji Fujii, Osaka (JP); Michiko Kaihotsu, Osaka (JP); Osamu Tanaka, Hashimoto-shi (JP)

Correspondence Address: BRINKS HOFER GILSON & LIONE, P.O. BOX 10395, CHICAGO, IL, 60610, US

(73) Assignee: KONICA MINOLTA PHOTO IMAGING, INC.

(21) Appl. No.: 11/243,104

(22) Filed: Oct. 4, 2005

(30) Foreign Application Priority Data
Oct. 13, 2004 (JP) 2004-298634

(51) Int. Cl. G03B 17/00

(52) U.S. Cl. 396/299

(57) ABSTRACT

A digital camera has an operation portion including at least one main operation member and provided on the back surface of a camera body, and a slide portion including a main display device and provided on the back surface of the camera body. The slide portion is sidable between a housed position that covers the operation portion and an image capturing position that exposes the operation portion on the camera body.

### CROSS-REFERENCE TO RELATED APPLICATION

This application is based on Japanese Patent Application No. 2004-298634 filed in Japan on Oct. 13, 2004, the entire content of which is hereby incorporated by reference.

### BACKGROUND OF THE INVENTION

1. Field of the Invention

The present invention relates to a digital camera, and more particularly, to a digital camera provided with a large-size display device.

2. Description of the Related Art

Digital cameras that record images as electronic information are typically provided with a display device such as a liquid crystal panel on the back surface of the camera body to confirm the captured images at the time of image capturing and to confirm the recorded images. Digital cameras are required to have a larger display device with high viewability and have a small camera body.

On the back surface of the digital camera body, operation members necessary for the user to perform the zooming operation and the like at the time of image capturing and a grip portion for holding the camera body are necessarily provided. For this reason, in small-size digital cameras, the size of the display device is limited, so that the requirement for a larger-size display device cannot be met.

An electronic camera has conventionally been proposed in which since the camera body having a large-size monitor can be housed in the grip portion, the camera body can be made compact when carried and a large-size monitor can be used at the time of image capturing. In the camera of this structure, however, since a large grip that covers the camera body is provided, the grip is a new factor that obstructs the size reduction of the camera.

### SUMMARY OF THE INVENTION

A main object of the present invention is to provide a digital camera in which a large-size display device is provided and the camera body is small in size.

Another object of the present invention is to provide a digital camera in which a large-size display device is provided and operability is not impaired.

The above-mentioned objects of the present invention are attained by providing a digital camera comprising an operation portion having at least one main operation member and provided on a back surface of a camera body, and a slide portion having a main display device and provided on the back surface of the camera body. The slide portion is slidable between a housed position that covers the operation portion and an image capturing position that exposes the operation portion on the camera body.

These and other objects, advantages and features of the invention will become apparent from the following description thereof taken in conjunction with the accompanying drawings, which illustrate specific embodiments of the invention.

### BRIEF DESCRIPTION OF DRAWINGS

These and other objects, advantages and features of the invention will become apparent from the following description thereof taken in conjunction with the accompanying drawings in which:

FIG. 1 is a front view of a digital camera according to a first embodiment of the present invention;

FIG. 2 is a perspective view viewed from the back of the camera body when a slide portion of the digital camera of FIG. 1 is situated in a housed position;

FIG. 3 is a perspective view viewed from the back of the camera body when the slide portion of the digital camera of FIG. 1 is situated in a image capturing position;

FIG. 4 is a perspective view viewed from the front of the camera body when the slide portion of the digital camera of FIG. 1 is situated in the image capturing position;

FIG. 5 is a view showing the system configuration of the digital camera of FIG. 1;

FIG. 6 is a perspective view, viewed from the back of the camera, showing an example in which main operation members of an operation portion are retracted in the camera body when the slide portion of the digital camera of FIG. 1 is situated in the housed position;

FIG. 7 is a perspective view showing a structure for retracting the main operation members in the digital camera of FIG. 6;

FIG. 8a is a view showing a condition where the main operation members are retracted in the camera body when the slide portion of the digital camera of FIG. 6 is situated in the housed position;

FIG. 8b is a view showing a condition of an operation portion substrate and the main operation members when the slide portion of the digital camera of FIG. 6 starts to be moved;

FIG. 8c is a view showing a condition where the main operation members protrude from the operation portion by the movement of the slide portion of the digital camera of FIG. 6;

FIG. 9 is a perspective view, viewed from the back of the camera body, showing an example in which the operation portion is retracted in the camera body when the slide portion of the digital camera of FIG. 1 is situated in the housed position;

FIG. 10 is a perspective view showing a structure for retracting the operation portion in the digital camera of FIG. 9;

FIG. 11a is a view showing a condition where the operation portion is retracted in the camera body when the slide portion of the digital camera of FIG. 9 is situated in the housed position;

FIG. 11b is a view showing a condition of the operation portion when the slide portion of the digital camera of FIG. 9 starts to be moved;

FIG. 11c is a view showing a condition where the operation portion protrudes from the camera body by the movement of the slide portion of the digital camera of FIG. 9;

FIG. 12 is a perspective view, viewed from the front, of a digital camera according to a second embodiment of the present invention;

FIG. 13 is a back view when the slide portion of the digital camera of FIG. 12 is situated in the housed position; and

FIG. 14 is a back view when the slide portion of the digital camera of FIG. 12 is situated in the image capturing position.

### DESCRIPTION OF THE PREFERRED EMBODIMENTS

Hereinafter, embodiments of the digital camera according to the present invention will be described with reference to the drawings.

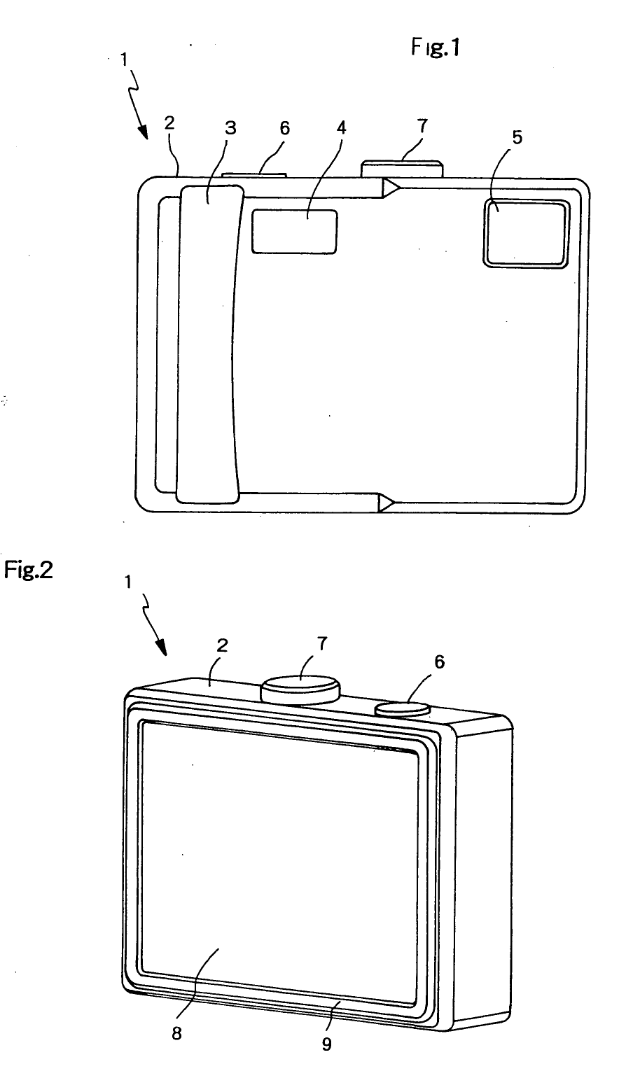

FIG. 1 shows a digital camera 1 according to a first embodiment of the present invention. In the digital camera 1, a grip 3 for the user to hold the camera when using the camera, a flash 4 and a lens 5 are provided on the front surface of a box-shaped camera body 2, and a release button 6 and a dial switch 7 for performing powering on and off and mode setting are provided on the top surface of the camera body 2.

As shown in FIG. 2, a slide portion 9 having a main display device 8 is provided on the back surface of the digital camera 1. The slide portion 9 is substantially as large as the projected area of the camera body 2. The main display device 8 comprising, for example, a liquid crystal panel is a large-size display device occupying substantially the entire area of the surface of the slide portion 9 (the back surface side of the digital camera 1).

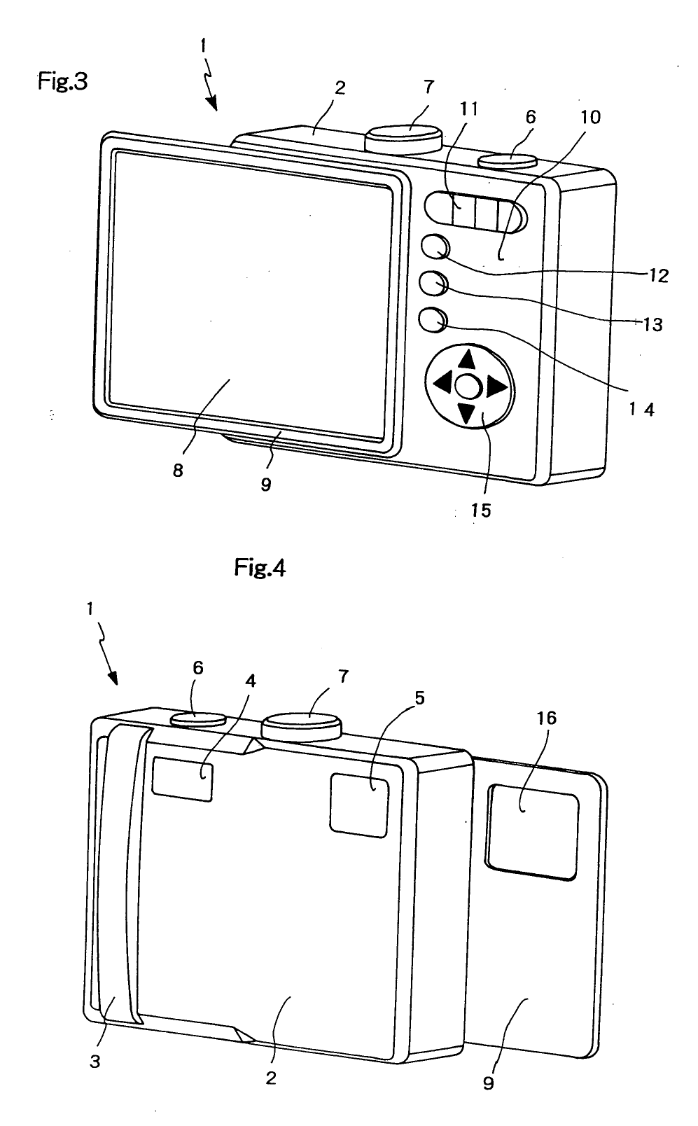

The slide portion 9 is slidable between a housed position shown in FIG. 2 and an image capturing position shown in FIG. 3 on the camera body 2. When the slide portion 9 is slid to the image capturing position as shown in FIG. 3, the left side part of the slide portion 9 protrudes from the camera body 2 so that an operation portion 10 is exposed on the right side of the slide portion 9. On the operation portion 10, the following five main operation members are provided: a zoom button 11 for performing the zooming operation at the time of image capturing; mode buttons (a menu button 12 for displaying a menu screen on the liquid crystal panel, a QV (quick view: displaying the captured image on the liquid crystal panel immediately after the image capturing operation)/deletion (deleting the image displayed by quick view) button 13, and a self-timer button 14); and a four-way key 15 for performing detailed function settings.

As shown in FIG. 4, a sub display device 16 comprising, for example, a small-size liquid crystal panel is provided on the back surface of a part of the slide portion 9 that is protruding from the camera body 2 (the front surface side of the digital camera 1) under the condition where the slide portion 9 is slid to the image capturing position.

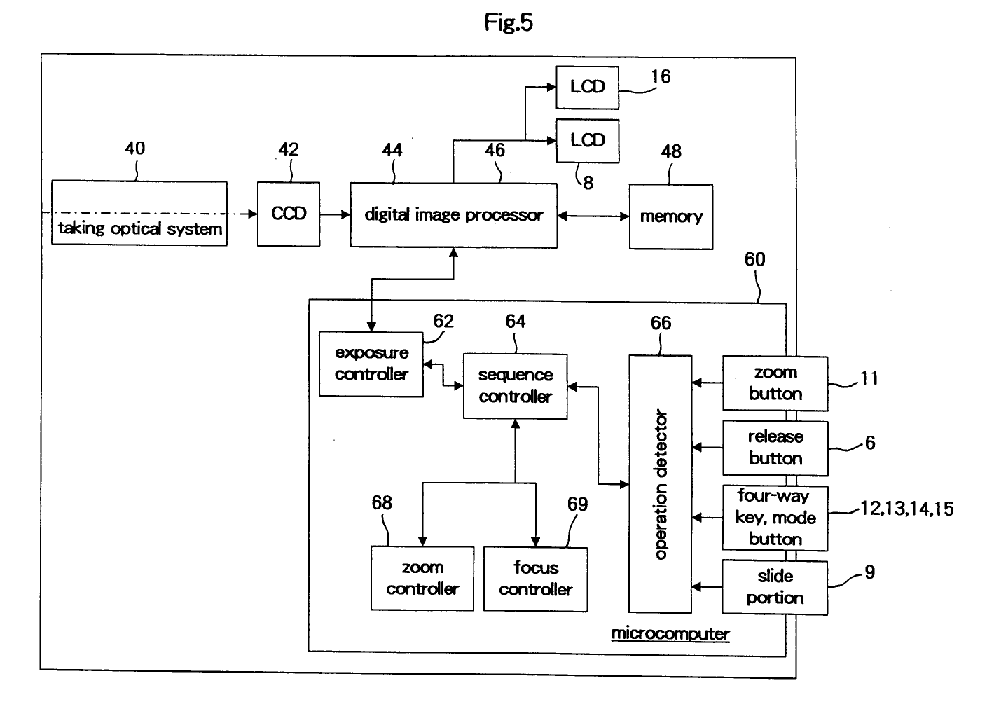

Next, the system configuration of the digital camera 1 will be described with reference to FIG. 5.

A taking optical system 40 including a taking lens directs the subject image to an image sensor 42 (for example, a CCD). The image sensor 42 photoelectrically converts the subject image to capture it. The image signal from the image sensor 42 undergoes, at a digital image processor 44, processings such as black level correction, color pixel interpolation, exposure compensation, gamma correction, contrast correction, sharpness correction, resolution conversion and image compression necessary for digital image processing and is outputted to the main display device 8 or the sub display device 16, and data storage or the like is performed on a memory 48. The main display device 8 or the sub display device 16 displays the live view image, images recorded in the memory 48, the camera condition and the like. The memory 48 is, for example, a flash memory card detachably attachable to the camera body and recording captured images.

The sequence system processing of the camera is performed by a sequence control microcomputer 60. The sequence control microcomputer 60 includes an exposure controller 62, a sequence controller 64, an operation detector 66, a zoom controller 68 and a focus controller 69. The operation detector 66 detects the condition of the release button 6, the slide portion 9, the zoom button 11, the mode buttons (the menu button 12, the QV/erasure button 13, and the self-timer button 14) and the four-way key 15, and transmits it to the sequence controller 64. The sequence controller 64 controls the sequence (operation condition) of the camera 1 based on the condition of the release button 6, the slide portion 9 and the main operation members 11, 12, 13, 14 and 15 of the camera. The exposure controller 62 determines the exposure condition of the camera from the output of a photometry sensor (not shown), and controls the exposure time of the image sensor 42 and the opening and closing condition of the shutter (not shown). The zoom controller 68 varies the focal length of the taking lens in response to the operation of the zoom button 11. The focus controller 69 detects the contrast condition of the image captured by the image sensor 42, determines the most suitable focus position, and drives the focusing lens in the taking lens.

The camera 1 operates roughly as follows by being controlled by the sequence control microcomputer 60: When the release button 6 is half depressed, the live view image is displayed on the main display device 8 or the sub display device 16 during the period to the shift to the sleep state by auto power-off (normally, for example, 30 seconds). The exposure control value is determined by operating the photometry sensor in response to half depressing the release button 6. Moreover, the focus position for focus adjustment is detected. When the full depression of the release button 6 is detected, an image of the subject is captured by the image sensor 42, and the captured image is recorded into the memory 48.

Subsequently, characteristics of the digital camera 1 having the above-described structure will be described. The digital camera 1 is provided with the large-size main display device 8 substantially as large as the projected area of the camera body 2, and at the time of image capturing, the operation portion 10 can be exposed by sliding the slide portion 9 to the image capturing position. Consequently, the user can grasp the operation portion 10 without covering the main display device 8 with a hand, select the enlargement ratio by operating the zoom button 11 provided on the operation portion 10, and release the shutter by the release button 6. For this reason, the digital camera 1 has excellent operability like conventional digital cameras while ensuring excellent viewability by the large-size main display device 8. Moreover, the digital camera 1 is excellent in portability because by sliding the slide portion 9 to the housed position, the overall size thereof can be reduced when image capturing is not performed.

Further, since the digital camera 1 has the sub display device 16 on the back surface of the part of the slide portion 9 protruding from the camera body 2, the image capturing area and composition can be confirmed also when the user captures an image of himself or herself. On the sub display device 16, the image may be displayed so as to be reversed left-to-right so that the image capturing direction can be easily operated when the users captures the image of himself or herself. Moreover, as an alternative, a mirror may be provided instead of the display device 16.

In the digital camera 1, in order that the user can operate the digital camera 1, it is necessary that the main operation members 11, 12, 13, 14 and 15 of the camera protrude from the operation portion 10. In order that the main operation members 11, 12, 13, 14 and 15 protrude from the operation portion 10, a space may be provided for avoiding the interference with the main operation members 11, 12, 13, 14 and 15 on the back side of the slide portion 9. Further, in order to reduce the thickness of the digital camera 1, the peripheral part of the main operation members 11, 12, 13, 14 and 15 of the operation portion 10 may be partially recessed.

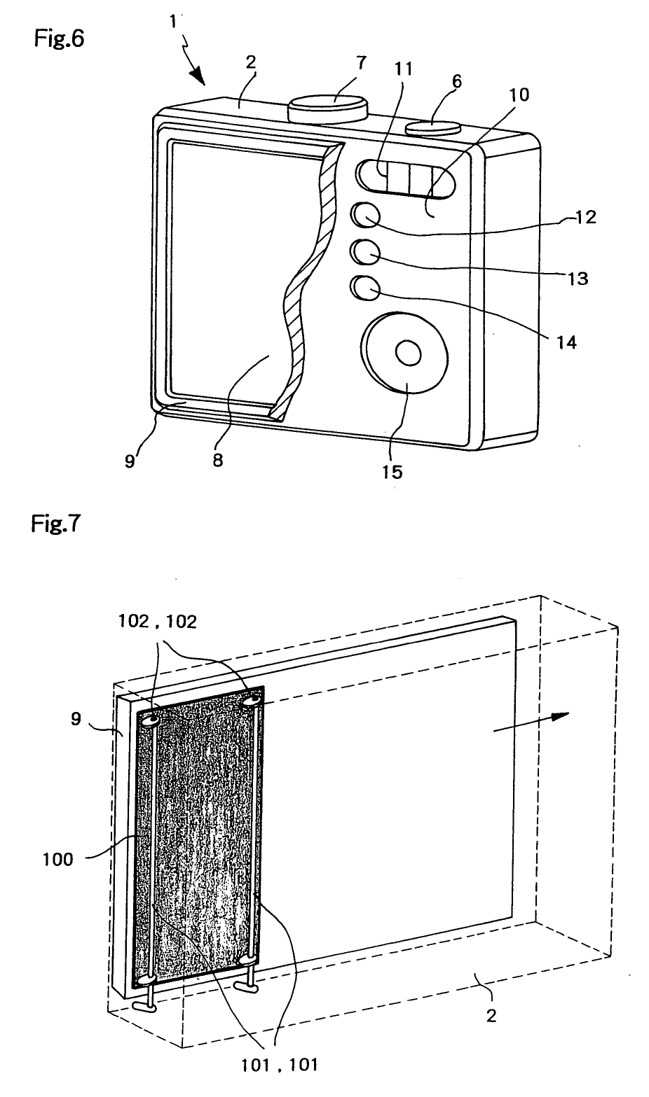

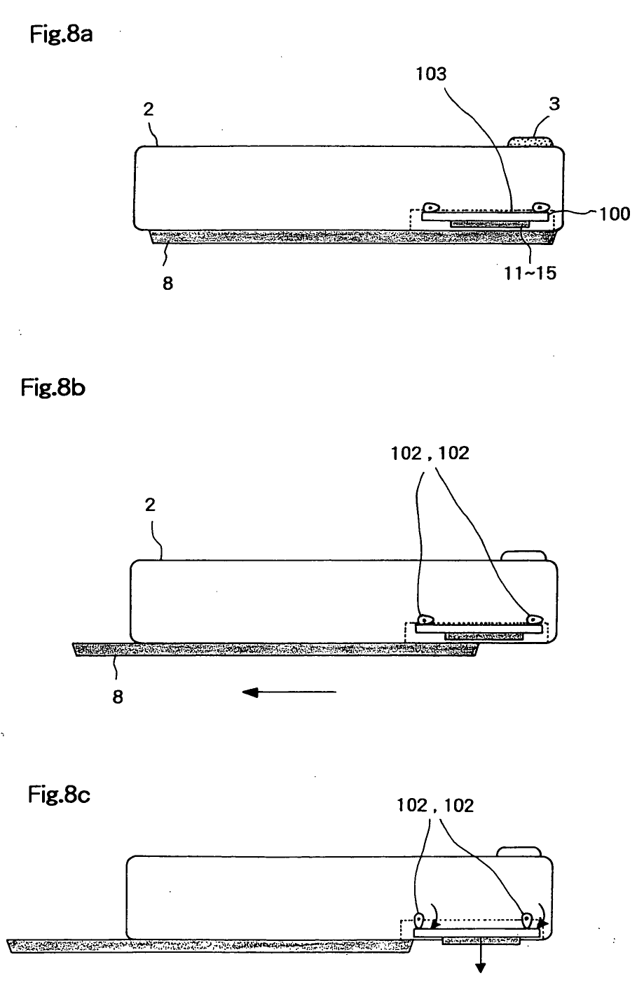

Moreover, in order to reduce the size of the digital camera 1 without increasing the area of the operation portion 10, as shown in FIG. 6, when the slide portion 9 is slid to the housed position, the main operation members 11, 12, 13, 14 and 15 may be retracted so as not to protrude from the operation portion 10 as the slide member 9 moves. As a structure for retracting the main operation members 11, 12, 13, 14 and 15, as shown in FIG. 7, a pair of cam members 102 rotatably supported by a pair of rotation shafts 101 are provided on the back surface of a substrate 100 of the operation portion 10. When the slide portion 9 is situated in the housed position shown in FIG. 8a, the main operation members 11, 12, 13, 14 and 15 are retracted in an operation portion cavity 103. When the slide portion 9 is moved toward the image capturing position by the user thereafter (FIG. 8b), the substrate 100 of the operation portion 10 is made to protrude from the back surface of the camera body by the cam members 102 that rotate as the slide portion 9 moves. Consequently, the main operation members 11, 12, 13, 14 and 15 provided on the surface of the substrate 100 of the operation portion 10 protrude from the operation portion 10 (FIG. 8c).

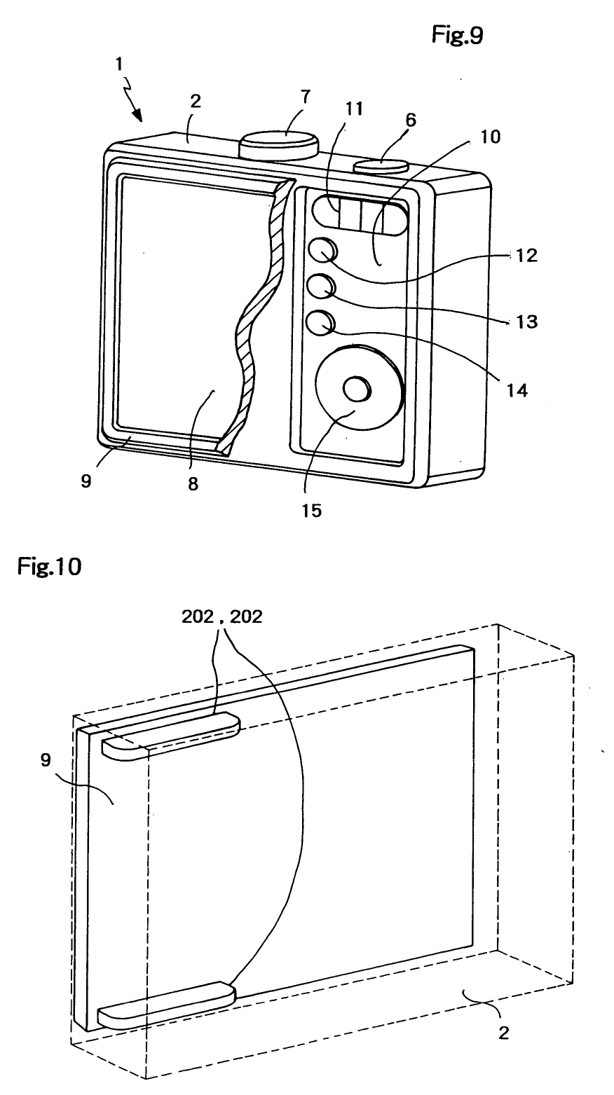

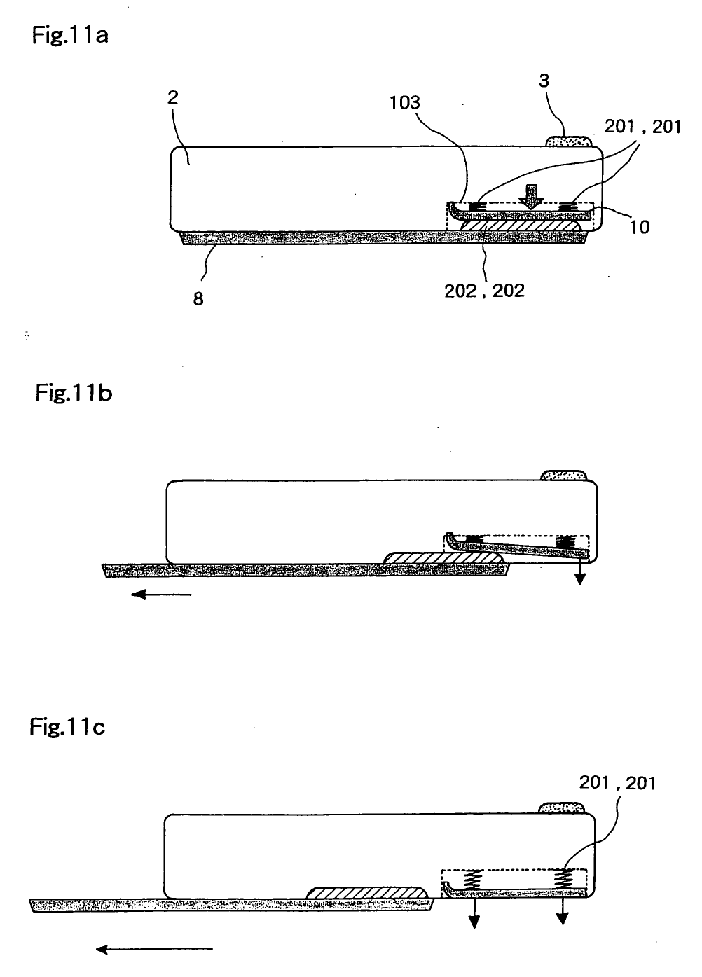

Moreover, as shown in FIG. 9, the operation portion 10 may be retracted into the camera body 2 as the slide portion 9 moves. As a structure for retracting the operation portion 10 into the camera body 2, as shown in FIG. 10, a pair of protrusions 202 are provided at ends of the back surface of the slide portion 9. When the slide portion 9 is situated in the housed position shown in FIG. 11a, the operation portion 10 having the main operation members 11, 12, 13, 14 and 15 is retracted in the operation portion cavity 103 by being pressed by the protrusions 202 provided on the back surface of the slide portion 9. When the slide portion 9 is moved toward the image capturing position by the user thereafter (FIG. 11b), the operation portion 10 protrudes from the back surface of the camera body by the pressing force of the pair of pushing members 201 provided on the back surface of the operation portion 10 (FIG. 11c).

Moreover, in the digital camera 1, the main display device 8 may be a touch panel where a touch panel switch is disposed. In this case, operations performed when already recorded image are played back and the like can be performed by the touch panel switch without the slide portion 9 slid to the image capturing position when image capturing is not performed.

Next, a different embodiment of the present invention will be described.

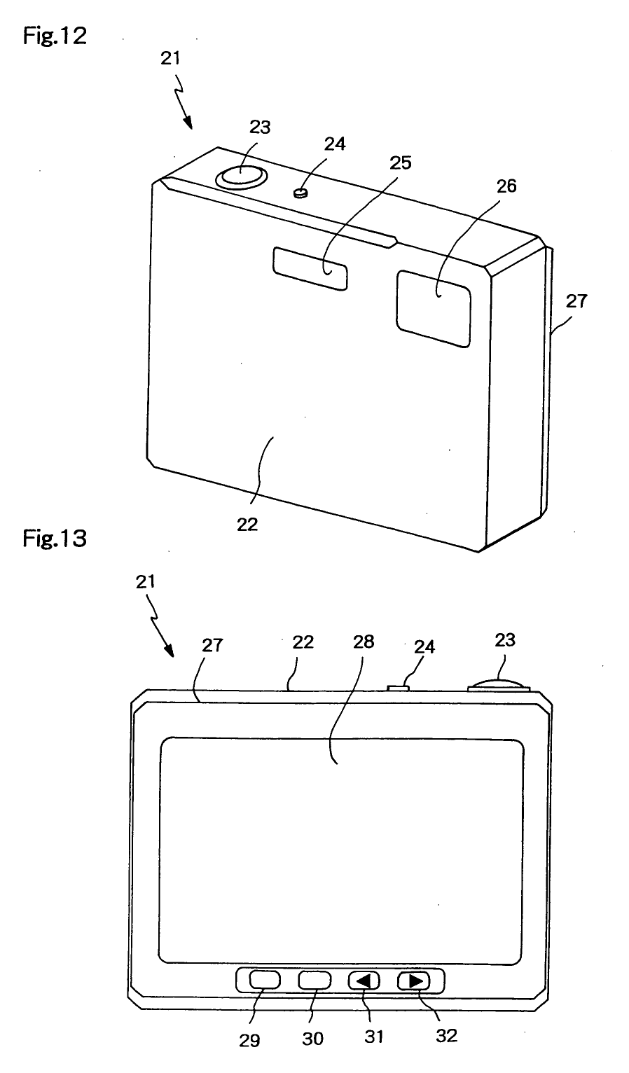

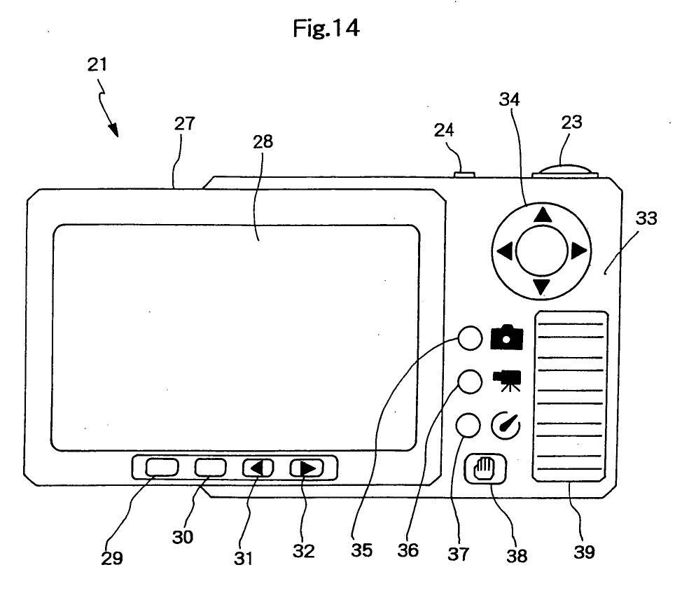

FIG. 12 shows a digital camera 21 according to a second embodiment of the present invention. In the digital camera 21, a release button 23 and a power switch 24 are provided on the top surface of a box-shaped camera body 22, a flash 25 and a lens 26 are provided on the front surface of the camera body 22, and a slide portion 27 is provided on the back surface of the camera body 22. The slide portion 27 on the back surface of the camera body 22 is sidable between a housed position where the slide portion 27 is within the image capturing area of the camera body 22 as shown in FIG. 13 and an image capturing position where the left side part of the slide portion 27 protrudes from the camera body 22 as shown in FIG. 14. On the slide portion 27, a main display device 28 comprising, for example, a liquid crystal panel is provided and four sub operation members 29, 30, 31 and 32 used for display setting are provided below the main display device 28. Moreover, the following five main operation members used for image capturing operations: a four-way key 34 used for an image capturing operation such as the zooming operation; a still image button 35 for starting still image image capturing; a moving image button 36 for starting moving image image capturing; a timer button 37 for starting image capturing by the self-timer; and a camera shake button 38 for setting the presence or absence of camera shake compensation, and a grip 39 to enable the user to easily hold the camera body 22 at the time of image capturing are provided on an operation portion 33 covered when the slide portion 27 is situated in the housed position and exposed when the slide portion is slid to the image capturing position.

Like the digital camera 1 of the first embodiment, the digital camera 21 having the above-described structure ensures the operability at the time of image capturing by exposing the operation portion 33 by sliding the slide portion 27 to the image capturing position while having the large-screen display device 28 with excellent viewability on the slide portion 27.

Further, in the digital camera 21 of the present embodiment, even when the slide portion 27 is situated in the housed position as shown in FIG. 13, an recorded image can be arbitrarily played back by performing display setting by the sub operation members 29, 30, 31 and 32 provided below the main display device 28 on the surface of the slide portion 27. Moreover, since the grip 39 is provided as shown in FIG. 14, the user can perform image capturing by operating the four-way key 34 while firmly holding the camera body 22.

In the present embodiment, as described in the first embodiment, the main operation members 34, 35, 36, 37 and 38 may be retracted in the operation portion 33 or the operation portion 33 may be retracted in the camera body 22, and a sub display device or a mirror may be provided on the back surface of the part of the slide portion 27 protruding from the camera body 22.

The digital camera according to the present invention is provided with the operation portion having the main operation members and the slide portion having the main display device on the back surface of the camera body. The slide portion is slidable between the housed position that covers the operation portion and the image capturing position that exposes the operation portion on the camera body.

According to this structure, since the main display device is disposed on the back surface of the camera body so as to be overlaid on the main operation members at the time of non-use of the digital camera when it is particularly desired that the digital camera be compact, a larger display device can be provided on a compact digital camera. Moreover, since the operation portion having the main operation members is exposed by sliding the slide portion having the main display device, the user can operate the operation members while grasping the operation portion as before, and operability is also ensured.

Moreover, in the digital camera according to the present invention, the slide portion may be substantially as large as the projected area of the camera body, and the main display device may occupy substantially the entire area of the back surface of the slide portion.

According to this structure, since the display device is large, viewability is high.

Moreover, in the digital camera according to the present invention, the main operation members may be retracted in the operation portion when the slide portion is situated in the housed position, and protrude from the operation portion when the slide portion is situated in the image capturing position. Or in the digital camera according to the present invention, the operation portion may be retracted in the camera body when the slide portion is situated in the housed position, and protrude from the camera body when the slide portion is situated in the image capturing position.

According to this structure, since no space for avoiding the interference with the main operation members is required between the slide portion situated in the housed position and the main operation members, the size of the digital camera can be further reduced.

Moreover, in the digital camera according to the present invention, a sub display device or a mirror may be provided on the back surface of the part of the slide portion protruding from the camera body in the image capturing position.

According to this structure, the captured image can be easily confirmed when the user shoots himself or herself.

Moreover, in the digital camera according to the present invention, a touch panel switch may be disposed on the main display device.

According to this structure, the digital camera can be operated even when the slide portion is situated in the housed position.

Moreover, in the digital camera according to the present invention, on the slide portion, a sub operation member may be provided on the periphery of the main display device, and the sub operation member may be used for display setting of the main display device.

According to this structure, even when the slide portion is situated in the housed position, the digital camera can be operated, and in particular, recorded images can be confirmed by performing display setting with the sub operation member.

Moreover, in the digital camera according to the present invention, the main operation members may be used for the image capturing operations.

According to this structure, since the operation members used for the image capturing operations are necessarily operated only at the time of image capturing and it is permissible that the operation members cannot be operated when the slide portion is situated in the housed position, operability is not impaired.

Moreover, in the digital camera according to the present invention, the camera body may be further provided with a grip held by the user, and the slide portion may cover the grip in the housed position and expose the grip in the image capturing position.

According to this structure, the digital camera can be provided with both a large-size display device with high viewability and a grip that enhances hand-holdability.

As described above, according to the present invention, a digital camera having a large-size display device without operability impaired can be provided.

Although the present invention has been fully described by way of examples with reference to the accompanying drawings, it is to be noted here that various changes and modifications will be apparent to those skilled in the art. Therefore, unless otherwise such changes and modifications depart from the scope of the present invention, they should be construed as being included therein.

What is claimed is:

1. A digital camera comprising:
an operation portion having at least one main operation member and provided on a back surface of a camera body;
a slide portion having a main display device and provided on the back surface of the camera body, said slide portion being slidable between a housed position that covers the operation portion and an image capturing position that exposes the operation portion on the camera body.

2. A digital camera as claimed in claim 1, wherein said slide portion is substantially as large as a projected area of the camera body.

3. A digital camera as claimed in claim 2, wherein said main display device occupies substantially the entire area of a surface of the slide portion.

4. A digital camera as claimed in claim 1, wherein said main operation member is retracted in the operation portion when the slide portion is in the housed position, and the main operation member protrudes from the operation portion when the slide portion is in the image capturing position.

5. A digital camera as claimed in claim 1, wherein said operation portion is retracted into the camera body when the slide portion is in the housed position, and the operation portion protrudes from the camera body when the slide portion is in the image capturing position.

6. A digital camera as claimed in claim 1, wherein a sub display device is provided on a back surface of the slide portion at a part thereof protruding from the camera body.

7. A digital camera as claimed in claim 1, wherein a mirror is provided on a back surface of the slide portion at a part thereof protruding from the camera body.

8. A digital camera as claimed in claim 1, wherein a touch panel switch is disposed on the main display device.

9. A digital camera as claimed in claim 1, wherein said slide portion has a sub operation member on the periphery of the main display device.

10. A digital camera as claimed in claim 9, wherein said sub operation member is used for display setting of the main display device.

11. A digital camera as claimed in claim 1, wherein the main operation member is used for the image capturing operations.

12. A digital camera as claimed in claim 1 further comprising:
a grip held by a user,
wherein said slide portion covers the grip in the housed position and exposes the grip in the image capturing position.

13. A digital camera as claimed in claim 4 further comprising:
a pair of cam members rotatably supported by a pair of rotation shafts and provided on a back surface of the operation portion.

14. A digital camera as claimed in claim 5 further comprising:
a pair of protrusions provided on the back surface of the slide portion.

15. An operating method of a digital camera, said method comprising the steps of
sliding to an image capturing position a slide portion having a main display device and provided on a back surface of a camera body;
exposing on the camera body an operation portion having at least one main operation member and provided between the slide portion and the camera body;
manipulating the main operation member on the operation portion for image capturing; and
sliding the slide portion to a housed position to cover the operation portion on the camera body when image capturing is finished.
